(19) United States
(12) Patent Application Publication
(10) Pub. No.: US 2006/0088939 A1
(43) Pub. Date: Apr. 27, 2006

(54) Methods for analysis of soil samples

(76) Inventor: Gordon Shanthakumar Rajendram, Hamilton (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 11/220,772

(22) Filed: Sep. 6, 2005

Related U.S. Application Data
(63) Continuation of application No. PCT/NZ04/00048, filed on Mar. 8, 2004.

(30) Foreign Application Priority Data
Mar. 7, 2003 (NZ) NZ 524645

(51) Int. Cl. G01N 24/00

(52) U.S. Cl. 436/31; 436/173

(57) ABSTRACT

The present invention relates to methods for the preparation and analysis of soil samples to determine the presence, concentration and/or volume of at least one component in a soil sample, including preparation steps of extracting the component from the sample by use of aqueous solution and, depending on the element, adding a complexing agent to the aqueous solution and soil mixture. The resulting mixture is then able to be analysed via NIR or UV/Vis spectrometry as the component, not normally detectable via NIR or UV/Vis spectrometry, is converted into an accurately measurable form. The methods of the present invention may be used to obtain a test results on site and within a time period of 10 to 45 minutes rather than a time period of days using present methods.

### RELATED APPLICATIONS

This application is a Continuation of, and claims priority under 35 U.S.C. § 120 to, PCT Application No. PCT/NZ2004/000048, filed on Mar. 8, 2004, and published in English as WO 2004/079365 A1 on Sep. 16, 2004, which claims priority to New Zealand Patent Application No. 524645, filed on Mar. 7, 2003, each of which is incorporated herein by reference in its entirety.

### FIELD OF THE INVENTION

The invention relates to methods for analysis of soil samples. More specifically, the invention relates to a method for determining the presence, concentration and/or volume of elements within soil wherein results may be obtained rapidly.

### DESCRIPTION OF THE RELATED ART

Testing of soils for key components is of importance in a wide variety of agricultural and horticultural applications. Often substantial economic decisions must be made dependent on the results of soil tests such as whether or not to plant crops, farm stock or apply fertilisers.

Current soil testing practice relies on laboratory testing using dried and ground soils, specialised methods and equipment, and associated user expertise.

Standard methods involve collecting multiple soil core samples in the field and transporting the samples in sterile containers to laboratories where the samples are dried. The drying process typically occurs overnight (or for at least 20 hours) at temperatures of 30 to 35° C. Following drying, the samples are ground, passed through a sieve to achieve the desired degree of uniformity and then finally tested for chemical or physical analysis using machinery such as a flame spectrophotometer, an atomic absorption (AA) spectrometer, or via inductively coupled AES spectrometry.

The above process is time consuming. It may take at least 2 days before analysis of the samples can commence. In addition, another 3 to 5 days are required for analysis and reporting due to equipment constraints and the need for careful handling. A known problem is that these methods are sensitive and minor variations can greatly affect the end result. The inherent delays equate to an average of 5 to 7 days before the laboratory results are received from the time of sampling.

A further complication with existing processes is that handling errors can lead to erroneous results that may occur during sample collection and subsequent transportation. For example, the core samples may be mixed incorrectly and/or samples mishandled during transport, for example by being subjected to extremes in temperature or humidity.

Given the above problems, it would be desirable to have a method that would allow for the testing of samples at the sampling location (on-site) and that was also accurate enough for determining the presence and/or composition of the soil sample in a relatively short period of time.

In the inventor's experience there appears to be no testing methods presently available which allow for a soil sample to be obtained and subsequently tested on site so that, for example, a farmer or advisor, may receive the results within a short space of time e.g. within an hour. It should be appreciated that a testing method that were to achieve this faster speed would allow for appropriate recommendations, for example in relation to application of fertiliser to be made and then implemented on the same day the soil sample was obtained.

Generally, routine tests completed on soil samples determine the presence and/or concentration and/or volume of elements present in a sample. Elements include: phosphorus, sulphur, pH (hydrogen content), and key cations including potassium (K), sodium (Na), calcium (Ca) and magnesium (Mg).

The most widely used and valuable of these tests are phosphorus (Olsen P), potassium, and pH in regard to fertiliser recommendations.

The existing method for analysing potassium (K) is to dry the sample as described above, extract the potassium from the soil sample using 1.0 M ammonium acetate (Helmke & Sparks 1996), and then test the extract for the presence, concentration and/or volume of potassium using either a flame spectrophotometer, an atomic absorption (AA) spectrometer, or inductively coupled AES spectrometry.

The main method for analysing phosphorus (P) is by use of a modified method of Olsen (Olsen et al 1954). A soil sample is dried as discussed above and phosphate is then extracted from the sample by adding 0.5 M sodium bicarbonate (NaHCO₃) and mixing in an end over end shaker for 30 minutes. The resulting extract is then further processed by addition of a molybdate compound which acts as a complexing agent for phosphate. The presence, concentration and/or volume of phosphorous present is then determined with UV/Vis spectrometry at a wavelength of 880 nm. This method is known as the Murphy and Riley method (Murphy & Riley 1962; Watanabe & Olsen 1965).

The existing method for analysing pH is by drying a soil sample as described above, and then adding water to the sample in a ratio of one part soil to two parts water. The soil sample/water combination is left overnight to mix and the pH content of the sample is then determined by use of a pH meter dipped into the soil/water mix.

It should be appreciated by those skilled in the art from the above description that each of the existing methods used at present requires specialist equipment that is not only expensive but can only be practically operated in a laboratory environment. Further, current methods are unduly timely to perform given the samples must be collected, transported, dried and prepared for analysis (e.g. element extraction) before analysis takes place. In practice, present analysis methods do not allow for on-site testing or prompt laboratory testing of samples.

One recent measurement technique development is that of near infrared spectrophotometers (NIR). NIR is used in a wide variety of industries to analyse the composition of various materials. NIR is particularly useful in determining the composition of materials, particularly if there are contaminants in certain materials. A major advantage of NIR over existing measurement devices is that the results of analysis can be obtained within a matter of minutes. In contrast, and as described above, existing test methods often take days to find a result, by which time it may no longer be convenient for the farmer or advisor to make a decision, for example regarding fertiliser application.

Further advantages of NIR analysis are that NIR is faster for use in sampling multiple measurements, and more forgiving of set up errors. For example, atomic absorption spectrometers require calibration after each measurement whereas NIR spectrometers typically require only one calibration for multiple samples.

However, analysis of labile elements extracted from soil samples cannot normally be performed directly by NIR or UV/Vis spectroscopy as these spectrophotometers cannot detect labile elements when in their native form.

Given the advantages of NIR such as speed and reliability it would be beneficial if a method of soil preparation could be developed so that NIR could be used to analyse labile elements. It may also be of use to develop soil preparation methods for use with UV/Vis spectrophotometers due to the fact there are currently portable versions available which could be used in the field.

It would also be preferable to have a method that can be completed on-site, that was quick yet still generated a sufficiently accurate result to allow for decisions to be made such as to whether or not extra nutrients are required by the soil.

It is an object of the present invention to address the foregoing problems or at least to provide the public with a useful choice.

All references, including any patents or patent applications cited in this specification are hereby incorporated by reference. No admission is made that any reference constitutes prior art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### SUMMARY OF THE INVENTION

For the purposes of this specification, the term ‘complexing agent’ refers to a compound which is capable of complexing or chelating an element such that the element is reversibly bound to the compound.

The term ‘UV/Vis’ refers to the ultra violet to visible light range or wave lengths between 10 nm and 1000 nm.

The term ‘NIR’ refers to the near infrared light range or wave lengths between 400 to 2500 nm.

The term ‘sample’ refers to at least one, but preferably several cores taken from the area or region of soil to be tested.

The term ‘component’ refers to any portion of the chemical or physical composition of soil. Consequently the term ‘component’ should be taken to include, but not be limited to: elements; compounds, such as nitrates, phosphates, sulphates and so forth; and properties such as pH.

According to one aspect of the present invention there is provided a method for determining the presence, concentration and/or volume of at least one component in a soil sample, the method including steps of:
a) adding at least one aqueous solution to a soil sample;
b) adding at least one complexing agent to a mixture from step (a);
c) analysing the result of step (b) via NIR spectrometry;
characterised in that steps (a) and (b) prepare the sample in manner that is suitable for NIR spectrometry. In some embodiments, step (a) is completed within 10 minutes. In some embodiments, step (a) is completed under pressure for a time period of 30 to 45 seconds.

According to a further aspect of the present invention there is provided a method for determining the presence, concentration and/or volume of at least one component in a soil sample, the method including steps of:
a) adding at least one aqueous solution to a soil sample;
b) adding at least one complexing agent to a mixture from step (a);
c) analysing the result of step (b) via UV/Vis spectrometry;
characterised in that steps (a) and (b) prepare the sample in manner that is suitable for UV/Vis spectrometry. In some embodiments, step (a) is completed within 10 minutes. In some embodiments, step (a) is completed under pressure for a time period of 30 to 45 seconds.

According to a further aspect of the present invention there is provided a method for determining the presence, concentration and/or volume in a soil sample of components selected from the group including: sulphur, carbon, pH, and combinations thereof, the method including steps of:
a) adding at least one aqueous solution to a soil sample;
b) analysing the result of step (a) via NIR spectrometry;
characterised in that steps (a) and (b) prepare the sample in manner that is suitable for NIR spectrometry.

According to a further aspect of the present invention there is provided a method for determining the presence, concentration and/or volume in a soil sample of components selected from the group including: sulphur, carbon, pH, and combinations thereof, the method including steps of:
a) adding at least one aqueous solution to a soil sample;
b) analysing the result of step (a) via UV/Vis spectrometry;
characterised in that steps (a) and (b) prepare the sample in manner that is suitable for UV/Vis spectrometry.

According to a further aspect of the present invention there is provided a method for determining the presence, concentration and/or volume of at least one component in a soil sample, the method including steps of:
a) adding at least one aqueous solution to a soil sample;
b) adding at least one complexing agent to a mixture from step (a);
c) analysing the result of step (b) via NIR or UV/Vis spectrometry;
characterised in that steps (a) and (b) prepare the sample in manner that is suitable for NIR or UV/Vis spectrometry, and further characterised in that step (a) is completed within 10 minutes, or is completed under pressure for a time period of 30 to 45 seconds.

The sample can be field moist, or can be at least in part dried. The component can be an element. The element can be, for example, phosphorus, sulphur, pH (hydrogen content), nitrogen, potassium (K), sodium (Na), calcium (Ca) and magnesium (Mg), or combinations thereof. An extra step of separating the liquid extract from the residual solids can be included between steps (a) and (b). The separation method can be, for example, filtration or centrifugation. The soil samples can be prepared for analysis in-situ where at least one aqueous solution of step (a) and/or at least one complexing agent of step (b) are applied directly to the sample area before the sample is removed from the ground. The aqueous solution used in step (a)can be selected from the group consisting of: sodium bicarbonate, sodium chloride, caesium chloride, water, dye solutions, and combinations thereof. The dye solutions can be selected, for example, from resazurin and a universal pH indicator. The mixture from step (a) can be decolourised. The decolourising can be done, for example, by addition of 1 to 2 grams of charcoal which is then separated from the extract by filtration. The decolourising can also be done by passing the extract through a charcoal filter. The complexing agent can be, for example, a binding or chelating compound which specifically binds to the component or components to be analysed. The complexing agent used in step (b) can be selected, for example, from sodium tetraphenylborate (NaTPB), ammonium molybdate (Olsen P colouring agent), ascorbic acid, ethylene diamine tetra acetate (EDTA) or other known chelating agents, nitrilo-triacetic acid (NTA), DTPA, hydroxylethylenediamine triacetic acid (HEDTA), PDTA or EDDHA. Steps (a) and (b) can be completed at substantially the same time.

According to a further aspect of the present invention there is provided a prepared soil extract for NIR spectrometry analysis, wherein the extract includes at least one aqueous solution and at least one complexing agent adapted to extract components in the soil into a form capable of being analysed via NIR spectrometry.

According to a further aspect of the present invention there is provided a prepared soil extract for UV/Vis spectrometry analysis, wherein the extract includes at least one aqueous solution and at least one complexing agent adapted to extract components in the soil into a form capable of being analysed via UV/Vis spectrometry.

According to a further aspect of the present invention there is provided a prepared soil extract for NIR spectrometry analysis, wherein the extract includes at least one aqueous solution adapted to extract components selected from: sulphur, carbon, pH, and combinations thereof, in the soil into a form capable of being analysed via NIR spectrometry.

According to a further aspect of the present invention there is provided a prepared soil extract for UV/Vis spectrometry analysis, wherein the extract includes at least one aqueous solution adapted to extract components selected from: sulphur, carbon, pH, and combinations thereof, in the soil into a form capable of being analysed via UV/Vis spectrometry.

In an additional embodiment of the invention, a method for determining the presence, concentration and/or volume in a soil sample of properties selected from sulphur, carbon, pH, and combinations thereof is provided, by
a) adding at least one aqueous solution to a soil sample; and
b) analysing the result of step (a) via NIR spectrometry;
where step (a) is completed within 10 minutes, and where step (a) prepares the sample in a manner suitable for NIR spectrometry.

In a further embodiment of the invention, a method for determining the presence, concentration and/or volume in a soil sample of properties selected from sulphur, carbon, pH, and combinations thereof is provided, by
a) adding at least one aqueous solution to a soil sample; and
b) analysing the result of step (a) via NIR spectrometry;
where step (a) is completed under pressure for a time period of 30 to 45 seconds, and further wherestep (a) prepares the sample in a manner suitable for NIR spectrometry.

In an additional embodiment of the invention, a method for determining the presence, concentration and/or volume in a soil sample of properties selected from sulphur, carbon, pH, and combinations thereof is provided, by a) adding at least one aqueous solution to a soil sample; and
b) analysing the result of step (a) via UV/Vis spectrometry;
where step (a) is completed within 10 minutes, and further wherestep (a) prepares the sample in a manner suitable for UV/Vis spectrometry.

In a yet further embodiment of the invention, a method for determining the presence, concentration and/or volume in a soil sample of properties selected from sulphur, carbon, pH, and combinations thereof is provided, by
a) adding at least one aqueous solution to a soil sample; and
b) analysing the result of step (a) via UV/Vis spectrometry;
where step (a) is completed under pressure for a time period of 30 to 45 seconds, and further wherestep (a) prepares the sample in a manner suitable for UV/Vis spectrometry.

In an additional embodiment of the invention, a method for determining the concentration of potassium in a soil sample is provided, by

a) adding an aqueous solution of sodium bicarbonate to a soil sample;

b) adding sodium tetraphenylborate (NaTPB) to the mixture from step (a); and

c) analysing the result of step (b) via NIR spectrometry;
where step (a) is completed within 10 minutes, and where steps (a) and (b) prepare the sample in a manner suitable for NIR spectrometry.

In a further embodiment of the invention, a method for determining the concentration of potassium in a soil sample is provided, by

a) adding an aqueous solution of sodium bicarbonate to a soil sample;

b) adding sodium tetraphenylborate (NaTPB) to the mixture from step (a); and

c) analysing the result of step (b) via NIR spectrometry;
where step (a) is completed under pressure for a time period of 30 to 45 seconds, and where steps (a) and (b) prepare the sample in a manner suitable for NIR spectrometry.

In an additional embodiment of the invention, a method for determining the concentration of Olsen P phosphorus in a soil sample is provided, by

a) adding an aqueous solution of sodium bicarbonate to a soil sample;

b) adding ammonium molybdate (Olsen P colouring agent) to the mixture from step (a) and degassing the sample; and

c) analysing the result of step (b) via NIR spectrometry;
where step (a) is completed within 10 minutes, and where steps (a) and (b) prepare the sample in a manner suitable for NIR spectrometry.

In a further embodiment of the invention, a method for determining the concentration of Olsen P phosphorus in a soil sample is provided, by

a) adding an aqueous solution of sodium bicarbonate to a soil sample;

b) adding ammonium molybdate (Olsen P colouring agent) to the mixture from step (a) and degassing the sample; and

c) analysing the result of step (b) via NIR spectrometry;
where step (a) is completed under pressure for a time period of 30 to 45 seconds, and where steps (a) and (b) prepare the sample in a manner suitable for NIR spectrometry.

The present invention broadly relates to a method of sample preparation and analysis that allows for the use of NIR or UV/Vis spectrometry to analyse the sample thus taking advantage of the increased speed and reliability of NIR and UV/Vis spectrometry. It is the inventor's experience that NIR and UV/Vis spectrometry are possible as the method of the present invention measures the presence, concentration and/or volume of a component, typically an element by reference to the component in its complexed form as opposed to its native form i.e. the form in which the element or component naturally occurs in the sample. By extracting the component into its complexed form, the NIR or UV/Vis spectrometer device can detect and measure the component.

Generally, the analysis carried out will determine the concentration of a component within a sample by converting the component from its ionic form and/or low concentration into a detectable form such as a concentrated and/or complexed molecule, a colour change, precipitate formation and the like. It is the inventor's understanding that the component needs to be converted to include one or more covalent bonds or a chromophore type compound so that it may be analysed via NIR or UV/Vis spectrometry.

It is the inventor's experience that the method of the present invention may be completed using field moist samples without deterioration in sample accuracy beyond that required for the purposes of making a commercial decision, such as determining whether or not fertiliser application is required. It is envisaged that through further testing practice, the accuracy will be sufficient for all but those situations where the most stringent of accuracies is required.

As an alternative, dried and/or semi-dried samples may be used without departing form the scope of the invention as described.

It should be appreciated however by those skilled in the art, that by removal of all or part of the drying step, the time required to obtain a result is significantly reduced, the cost of the test is decreased, and the amount of equipment required to perform the analysis is decreased. A further benefit is that the option of on-site testing is possible.

Preferably, the component measured is an element or group of elements. Preferably, elements are selected from phosphorus (P), sulphur (S), pH (hydrogen (H) content), nitrogen (N), potassium (K), sodium (Na), calcium (Ca) and magnesium (Mg). However, this should not be seen as limiting as other elements may also be measured by the present invention. Most preferably, elements measured via the method of the present invention may be phosphorus and potassium.

In an embodiment where pH is determined, the concentration of hydrogen ions may be established using the method of the present invention from which the soil pH is determined using known techniques.

In one alternative embodiment an extra step may be included between steps (a) and (b) of separating the aqueous phase including the element to be analysed from the residual solids. However, it is the applicant's experience that this is not an essential step and that a useful result can be determined even with residual solids present within the sample.

In embodiments where a separation step is included, separation methods may include filtration or centrifugation.

Preferably, the method of the present invention may determine the presence of a component within a sample. More preferably, the method may determine the volume and/or concentration of a component. Most preferably, the method determines the concentration of an element.

According to a further aspect of the present invention there is provided a method of preparing a soil sample for analysis including applying at least one aqueous solution and/or at least one complexing agent directly to the sample area before a sample or samples are removed from the ground. It should be appreciated that, via in-situ preparation as described above, further time may be saved in the analysis process.

Preferably, the aqueous solution used in step (a) may be selected from: sodium bicarbonate (NaHCO3), sodium chloride (NaCl), caesium chloride (CsCl2), water or dye solutions. In one preferred embodiment the aqueous solution may be sodium bicarbonate (NaHCO3). In another preferred embodiment the aqueous solution may be water. In a further embodiment dyes include resazurin or universal pH indicator. However, it should be appreciated by those skilled in the art that other aqueous solutions may be employed as would be apparent to a person skilled in the art.

Preferably, the aqueous solution is mixed with the soil sample during step (a) for a time period of less than 15 minutes and more preferably, less than 10 minutes. It is the inventor's experience that a time period of less than 15 minutes mixing is sufficient to achieve a desired level of accuracy. In an alternative embodiment, pressure is used during step (a) to extract the component or components. It is the inventor's experience that by use of pressure an accurate result is still obtained from a 30 to 45 second pressure extraction. It should be appreciated by those skilled in the art that this shorter time period represents an improvement on prior art methods that require over 30 minutes time for mixing.

Optionally decolourisation of the extract may be required after aqueous solution is added, for example when sodium bicarbonate (NaHCO3) is used. Preferably, the extract is decolourised by the addition of a small amount of charcoal (approximately 1 to 2 g) which is then separated from the extract by filtration or by passing the extract through a charcoal filter.

Preferably, the complexing agent may be a binding or chelating compound which specifically binds to the component or components to be analysed.

In a further embodiment, addition of a complexing agent may result in the formation of a precipitate. In an alternative embodiment, the addition of a complexing agent results in a change of colour. The examples given for addition of a complexing agent should not be seen as limiting as it should be appreciated by those skilled in the art that alternative indicators may also be used, if such indicators are used at all.

Preferably, the complexing agent used in step (b) may be selected from: sodium tetraphenylborate (NaTPB), ammonium molybdate (also called Olsen P colouring agent), ascorbic acid, ethylene diamine tetra acetate (EDTA), resazurin, or other known chelating agents for example; nitrilo-triacetic acid (NTA), DTPA, hydroxyl ethylenediamine triacetic acid (HEDTA), PDTA and EDDHA. However, it should be appreciated by those skilled in the art that that other complexing agents may be employed as would be apparent to a person skilled in the art.

In preferred embodiments, for potassium measurement, a soil sample is combined with sodium bicarbonate as the aqueous solution and mixed for approximately 10 minutes. The liquid extract is separated from the solid residue by filtration and sodium tetraphenylborate (NaTPB) is added as the complexing agent. The complexed sample is then either presented to an NIR or UV/Vis spectrometer in a vial, or poured into a Petri dish and the dish sample analysed.

In preferred embodiments for Olsen P measurement (phosphorus), a soil sample is combined with sodium bicarbonate as the aqueous solution and mixed for approximately 10 minutes. The liquid extract is separated from the solid residue by filtration, Olsen P colouring agent added and then degassed. Degassing may be either via ultrasound or simple shaking of the sample. The complexed sample is then either presented to an NIR or UV/Vis spectrometer in a vial, or poured into a Petri dish and the dish sample analysed.

Preferably, steps (a), (b) and (c) if present are completed at substantially the same time. It is envisaged that the preparation step will be automated to prevent handling errors and it should be appreciated that, by use of careful equipment design it may be possible to automate the measurement process so that the user need only collect the sample and all further preparation and measurement steps be undertaken by an apparatus.

In a further embodiment, soil collected for sampling may be placed within a permeable container such as a permeable plastic and step (a) and the complexing step (b) if present are completed by washing the solutions through the container or immersing the soil and container within the solutions.

It should be appreciated from the above description that there are provided methods for analysis of components in soil and soil samples prepared for analysis that have advantages over the prior art. One key advantage is the significant reduction in time taken to perform the analysis compared to prior art methods i.e. 10 to 45 minutes per analysis as opposed to 5 to 7 days or more using standard techniques. A further advantage is that the method of the present invention may be performed on-site, for example at a farm, thus removing the potential for handling errors at the sample collection stage and transport stage. A further advantage of the present invention is that wet samples can be used, thus reducing the amount of equipment required and therefore the cost of the analysis equipment.

### BRIEF DESCRIPTION OF THE DRAWINGS

Further aspects of the present invention will become apparent from the ensuing description which is given by way of example only and with reference to the accompanying drawings in which:

FIG. 1 Graph showing the relationship between NIR predicted Olsen P levels and base test wet chemistry for Olsen P;

FIG. 2 Graph showing the relationship between potassium levels predicted and potassium as measured via the present invention;

FIG. 3 Graph showing the relationship between Olsen P levels predicted and Olsen P as measured via the present invention;

FIG. 4 Graph showing the relationship between 10 gram per 100 ml Olsen P measurements made using a pressure extraction and NIR analysis versus a reference 30 minute extraction;

FIG. 5 Graph showing the relationship between 5 gram per 100 ml Olsen P measurements made using a pressure extraction and NIR analysis versus a reference 30 minute extraction; and,

FIG. 6 Graph showing the relationship between pH measured via NIR versus a reference method.

### DETAILED DESCRIPTION OF THE PREFERRED EMBODIMENT

### EXPERIMENTAL

Non-limiting examples illustrating the invention will now be provided. It will be appreciated that the description below is provided by way of example only and variations in materials and technique used which are known to those skilled in the art are contemplated.

### Example 1

1.1 Soil Sampling

Soil samples are obtained by using a standard 20 or 25 mm diameter corer of either 7.5 or 15 cm in length depending on whether the area where the sample is taken from is to be used for agricultural (7.5 cm) or horticultural (15 cm) purposes respectively. Each sample will normally contain 15 to 20 cores that are mixed and from which a representative sample or samples are taken.

1.2 Sample Preparation

Each sample is placed onto a tray and is dried in a vented oven at 30 to 35° C. for 24 to 72 hours. Where field moist samples are to be tested, this drying step is omitted.

Samples are then individually passed through a 2 mm sieve to homogenise the material and ground soil samples are collected.

1.3 Extraction Method

Five grams of soil as prepared above is added to an aqueous solution, in this example 100 ml of 0.5 M sodium bicarbonate (NaHCO₃) (pH 8.5) and stirred for 10 minutes or alternatively for approximately 30 seconds under pressure at approximately 70° C.

The liquid extract portion of the soil/aqueous solution mixture is then separated from the residual solid soil matter by filtration.

1.4 Decolourisation of the Extract

It is the applicant's experience that decolourisation of the liquid extract is an option. For example, when sodium bicarbonate (NaHCO₃) is used as the aqueous solution. Other aqueous solutions, such as sodium chloride (NaCl) do not require decolourisation.

Where decolourisation is completed, the liquid extract is decolourised by the addition of a small amount of charcoal (approximately 1 to 2 gm) which is then separated from the liquid extract by known means such as filtration. Alternatively, the liquid extract is decolourised by passing the liquid extract through a charcoal filter.

1.5 Complexing

1.5.1 Phosphate

Phosphate is preferably complexed by mixing the extract with ammonium molybdate as outlined in the Murphy Riley Method (Murphy & Riley 1962; Watanabe & Olsen 1965).

A 1400 μl aliquot of the filtrate is mixed with 800 μl of Murphy Riley Reagent (a standard combination of ammonium molybdate, ascorbic acid, sulphuric acid and water) and 150 μl of sulphuric acid and made up to a final volume of 10 ml with distilled water. The complexing mixture is left to mix long enough to allow the colour to develop (for approximately 10 minutes).

1.5.2 Potassium

Potassium is preferably complexed by mixing the extract with sodium tetraphenylborate (NaTPB). A solution containing 50 ml of water, 3.25 g sodium tetraphenylborate (NaTPB) and 2 mls of sodium hydroxide (NaOH) is prepared. A quantity of 1.0 ml of the complexing solution is added to the liquid extract.

1.6 Measurement via NIR Spectrometry

Complexed samples are then placed individually into a 100 ml petri-dish and placed into an NIR spectrometer. The NIR spectrometer simultaneously scans the sample from 400 to 1700 nm. The results from the NIR analysis are further calculated by Galactic Grams/32 PLS Software. It will be appreciated that other software may be used and this should not be seen as limiting.

1.7 Results

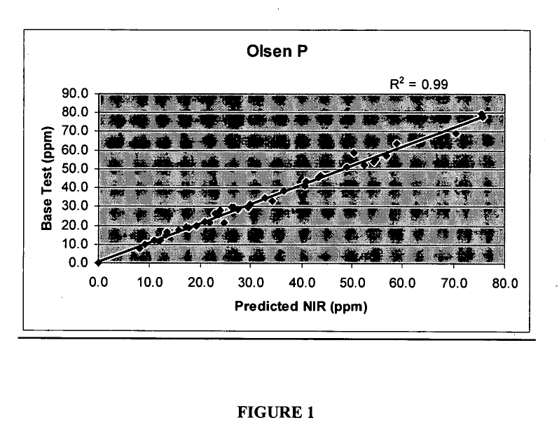

Referring to FIG. 1, it can be seen that the ability to complex samples prior to NIR measurements enables accurate determination of the amount of elements phosphorus and potassium in a sample.

An example is given for Olsen P (FIG. 1) to illustrate the prediction accuracy of the method, R²=0.99.

### Example 2

2.1 Samples

200 soil samples were selected according to their Olsen P content: 0-15, 15-30, 30-50, and >50 μg/g soil, with 50 samples in each Olsen P range. In this way, variation, if any due to soil type could be determined as well as accuracy of the method generally.

2.2 Measurements

2.2.1 NIR Equipment

A KES NIR unit was used for Example 2. KES NIR software was used. It will be appreciated that other types of NIR apparatus and/or software may be used without departing from the scope of the invention and this should not be seen as limiting.

Prior to measurements starting, the unit was characterised by performing 30 simultaneous measurements of the calibration tile and a Spectralon tile. The Spectralon transform and the calibration tile spectrum was based on these measurements. The calibration tile was scanned prior to each sample.

The following procedure was applied to each sample:

1. In a 120 ml vial, 5.00 g of sample was mixed with 100 ml sodium bicarbonate (NaHCO₃) as the aqueous solution and mixed for 10 minutes.

2. The mixture from step 1 was filtered to separate the liquid extract from the residual solids.

3. A 60 ml sample of liquid extract was placed in a 70 ml vial and analysed via NIR spectroscopy to determine the sulphur content.

4. 0.6 ml of sodium tetraphenylborate (NaTPhB) solution was added to the extract of step 3 following analysis and the vial was analysed via NIR spectroscopy to determine the potassium content.

5. The sample from step 4 was transferred to a 140 mm Petri dish and analysed via NIR spectroscopy for potassium determination in Petri dishes.

6. 9 ml of the original extract (obtained in step 2) was mixed with 47.25 ml Olsen P colouring agent in a 70 ml vial, allowed to react for 10 minutes, degassed using ultrasound, and analysed via NIR spectroscopy for Olsen P determination in a vial.

7. The sample from step 6 was transferred to a 140 mm Petri dish and analysed via NIR spectroscopy for Olsen P determination in Petri dishes.

It will be appreciated form the above description that, for potassium and Olsen P, samples were scanned both in sample vials and in Petri dishes. This was done to determine if any variation in results occurs due to the form in which the sample is presented to the NIR spectrometer. It should be appreciated by those skilled in the art that other sample containers may be used such as test tubes, flow systems and fibre optic probes, and the examples given should not be seen as limiting.

The experiment was carried out twice over a period of approximately one month to determine the stability/robustness of the method.

2.2.2 Reference Measurements

For reference, potassium content for each sample was determined in duplicate by atomic absorption spectroscopy on the sodium bicarbonate (NaHCO3) extracts obtained in step 2 above.

Olsen P reference data was determined in duplicate by a sodium bicarbonate (NaHCO3) extraction for 30 minutes, followed by the addition of Murphy Riley agent and analysis via UV/Vis spectrometry at 880 nm.

2.3 Results

2.3.1 Potassium (K)

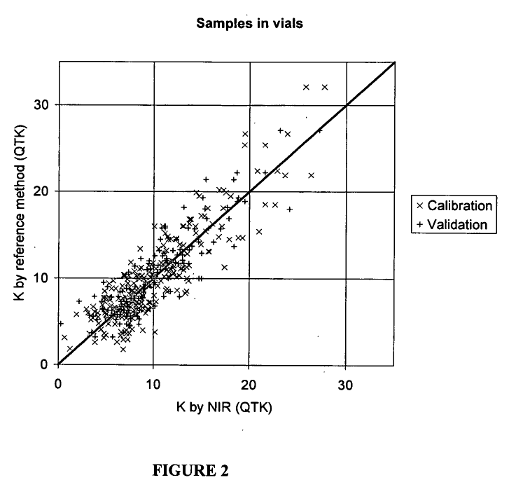

Referring to FIG. 2, vial results measured via NIR are compared to actual reference method tests, reported in Quick Test K (QTK) units on a weight basis.

The observed potassium accuracy was 2.44 QTK units for all samples in the validation set with a slightly better result in the main region of interest. The results ranged from 2 to 32 QTK and the repeatability (sᵣ) of the base test was 1.12 QTK so the obtained accuracy is a satisfactory result.

The repeatability is high (2.03 for the test set). This indicates that the repeatability may have a major influence on the accuracy and that if it is improved then it will affect the accuracy in a positive way. The repeatability of multiple determinations of the K value on the same prepared sample is approx. 0.8, so the influence from the instrument is only minor. Thus, if the sample handling is standardised to a larger extent, then an even better accuracy may be obtained.

2.3.2 Olsen P

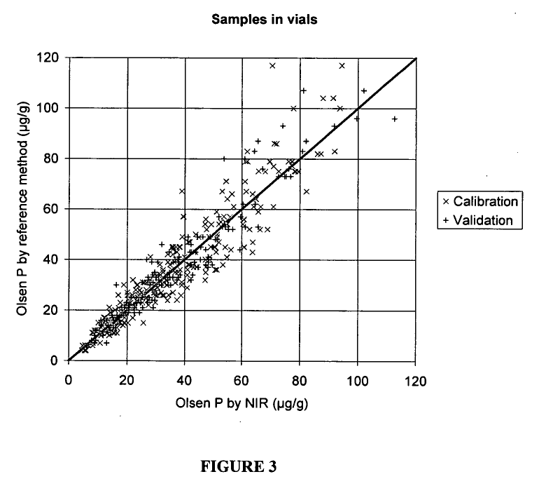

As shown in FIG. 3, vial results measured via NIR are compared to actual reference method tests, reported in μg/g soil.

All results were reported on a weight basis. The results ranged from 4 to 117 μg/g soil and the repeatability (sᵣ) of the base test ranged from 1.9 μg/g (in the 0-15 μg/g range) to 7.6 μg/g (in the >50 μg/g range).

Results obtained from samples in Petri dishes are slightly better, but the more complicated sample handling process for Petri dishes (i.e. pouring the sample into a Petri dish and avoiding waves on the sample surface) does not justify use only of this method.

2.4 Conclusions

From the results reported above it can be concluded that:
Potassium (K)
   Potassium can be determined with an accuracy of 2.44 QTK (2.20 QTK if only the region below 15 QTK is considered). The corresponding repeatability of the base test is 1.12 QTK.
   The best potassium results are obtained when using sample vials.
Olsen P
   Olsen P is determined with an excellent accuracy ranging from 2.5 (0-15 μg/g) to 11.4 μg/g (>50 μg/g). The corresponding repeatability for the base test is 1.9 and 7.6 μg/g.
   Results from samples in Petri dishes are slightly better than for sample vials, but sample handling (and errors related to it) is much simpler with the latter method.

### Example 3

### Olsen P Pressure Extraction

A series of 23 soil samples of varying Olsen P levels were collected and prepared by extraction with sodium bicarbonate. The extraction however was completed under pressure for a time period of 30 to 45 seconds and a temperature of approximately 70° C. The resulting Olsen P level was analysed using UV/Vis spectrometry for both a 5 g sample and 10 gram sample.

A reference test was also made on the same raw material (5 grams and 10 grams) using a standard 30 minute extraction and UV/Vis spectrometry analysis.

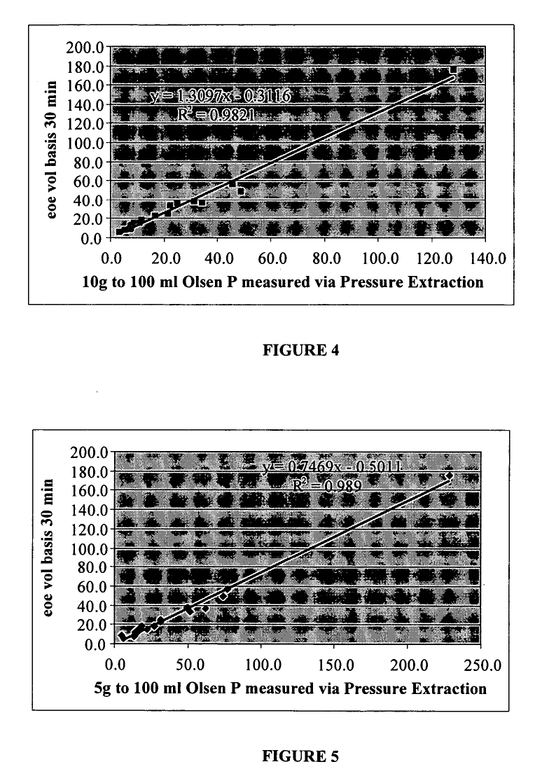

Referring to FIGS. 4 and 5, a good correlation was found between results found using the method of the present invention versus the reference technique, R²=0.98.

An observation made was that the pressure method may actually be a better indicator of phosphorus availability for plants. Lower phosphorus retention or lower phosphorus buffer capacity soils (i.e. sedimentary soils) have phosphorus easily extracted into solution compared to high buffered soils such as ash soils.

This property is highly correlated with the availability of phosphorus to plants because it directly affects the rate of diffusion.

### EXAMPLE 4

### pH Measurement

A series of soil samples of varying pH were collected and prepared by extraction with water. The extraction was completed for a time period of 10 minutes. The resulting pH level was determined by reference to hydrogen content using NIR spectrometry.

A reference test was also made on the same raw material using a standard 24 hour extraction time period and pH meter analysis.

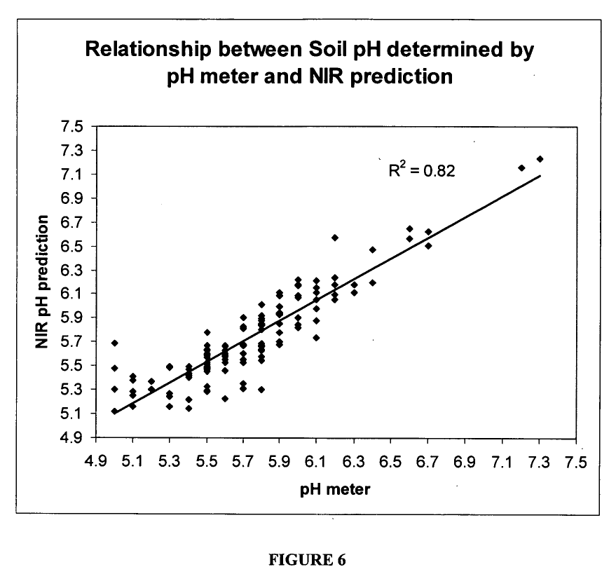

Referring to FIG. 6, it can be seen that a reasonable comparison was found regardless of soil type and pH level, R²=0.82.

### Example 5

### Sulphur, Carbon and Nitrogen Measurement

Samples are collected and mixed with sodium bicarbonate (NaHCO3) for a time period of 10 minutes after which the samples are filtered. Extracted samples are then transferred into a vial or Petri dish and measured via NIR spectrometry.

Examples have been given above to show preferred methods for analysis of soil samples for elements including phosphorus (Olsen P), potassium, pH, sulphur, carbon and nitrogen. These examples should not be seen as limiting as it should be appreciated by those skilled in the art that the methods of the present invention may be used to determine the presence, concentration and/or volume of other elements within a soil sample.

It should further be appreciated by those skilled in the art that the accuracies illustrated will increase as per normal measurement processes where, as the process is repeated and equipment and user skill improves, the degree of accuracy increases.

Further, examples have been given directed towards use of an NIR spectrometer. It should be appreciated by those skilled in the art that a UV/Vis spectrometer could also be used to determine the presence, concentration and/or volume of elements within a soil sample prepared using the methods described for the present invention.

Aspects of the present invention have been described by way of example only and it should be appreciated that modifications and additions may be made thereto without departing from the scope thereof as defined in the appended claims.

What is claimed is:

1. A method for determining the presence, concentration and/or volume of at least one component in a soil sample, comprising:
a) adding at least one aqueous solution to a soil sample;
b) adding at least one complexing agent to the mixture of step (a); and
c) analysing the result of step (b) via NIR spectrometry;
wherein step (a) is completed within 10 minutes, and further wherein steps (a) and (b) prepare the sample in a manner that is suitable for NIR spectrometry.

2. A method for determining the presence, concentration and/or volume of at least one component in a soil sample, comprising:
a) adding at least one aqueous solution to a soil sample;
b) adding at least one complexing agent to the mixture of step (a); and
c) analysing the result of step (b) via NIR spectrometry;
wherein step (a) is completed under pressure for a time period of 30 to 45 seconds, and further wherein steps (a) and (b) prepare the sample in a manner that is suitable for NIR spectrometry.

3. A method for determining the presence, concentration and/or volume of at least one component in a soil sample, comprising:
a) adding at least one aqueous solution to a soil sample;
b) adding at least one complexing agent to the mixture of step (a); and
c) analysing the result of step (b) via UV/Vis spectrometry;
wherein step (a) is completed within 10 minutes, and further wherein steps (a) and (b) prepare the sample in a manner that is suitable for UV/Vis spectrometry.

4. A method for determining the presence, concentration and/or volume of at least one component in a soil sample, comprising:
a) adding at least one aqueous solution to a soil sample;
b) adding at least one complexing agent to the mixture of step (a); and
c) analysing the result of step (b) via UV/Vis spectrometry;
wherein step (a) is completed under pressure for a time period of 30 to 45 seconds, and further wherein steps (a) and (b) prepare the sample in a manner that is suitable for UV/Vis spectrometry.

5. A method for determining the presence, concentration and/or volume of at least one component in a soil sample, comprising:
a) adding at least one aqueous solution to a soil sample;
b) adding at least one complexing agent to the mixture of step (a); and
c) analyzing the result of step (b) via NIR or UV/Vis spectrometry;
wherein step (a) is completed within 10 minutes or is completed under pressure for a time period of 30 to 45 seconds, and further wherein steps (a) and (b) prepare the sample in a manner that is suitable for NIR or UV/Vis spectrometry.

6. The method of claim 5, wherein the sample is field moist.

7. The method of claim 5, wherein the sample is at least in part dried.

8. The method of claim 5, wherein the component is an element.

9. The method of claim 8, wherein the elements tested are selected from the group consisting of: phosphorus, sulphur, pH (hydrogen content), nitrogen, potassium (K), sodium (Na), calcium (Ca) and magnesium (Mg), and combinations thereof.

10. The method of claim 5, wherein an extra step is included between steps (a) and (b) of separating the liquid extract from the residual solids.

11. The method of claim 10, wherein separation methods include filtration or centrifugation.

12. The method of claim 5, wherein the soil samples are prepared for analysis in-situ whereby at least one aqueous solution of step (a) and/or at least one complexing agent of step (b) are applied directly to the sample area before the sample is removed from the ground.

13. The method of claim 5, wherein the aqueous solution used in step (a) is selected from the group consisting of: sodium bicarbonate, sodium chloride, caesium chloride, water, dye solutions, and combinations thereof.

14. The method of claim 13, wherein the dye solutions are selected from resazurin and a universal pH indicator.

15. The method of claim 5, wherein the mixture from step (a) is decolourised.

16. The method of claim 15, wherein decolourising is completed by addition of 1 to 2 grams of charcoal which is then separated from the extract by filtration.

17. The method of claim 15, wherein decolourising is completed by passing the extract through a charcoal filter.

18. The method of claim 5, wherein the complexing agent is a binding or chelating compound which specifically binds to the component or components to be analysed.

19. The method of claim 1, wherein the complexing agent used in step (b) is selected from the group consisting of: sodium tetraphenylborate (NaTPB), ammonium molybdate (Olsen P colouring agent), ascorbic acid, ethylene diamine tetra acetate (EDTA) or other known chelating agents, nitrilo-triacetic acid (NTA), DTPA, hydroxyl ethylenediamine triacetic acid (HEDTA), PDTA and EDDHA.

20. The method of claim 1, wherein steps (a) and (b) are completed at substantially the same time.

21. The method for determining the presence, concentration and/or volume in a soil sample of properties selected from the group consisting of: sulphur, carbon, pH, and combinations thereof, comprising:
a) adding at least one aqueous solution to a soil sample; and
b) analysing the result of step (a) via NIR spectrometry;
wherein step (a) is completed within 10 minutes, and further wherein step (a) prepares the sample in a manner suitable for NIR spectrometry.

22. A method for determining the presence, concentration and/or volume in a soil sample of properties selected from the group consisting of: sulphur, carbon, pH, and combinations thereof, comprising:
a) adding at least one aqueous solution to a soil sample; and
b) analysing the result of step (a) via NIR spectrometry;
wherein step (a) is completed under pressure for a time period of 30 to 45 seconds, and further wherein step (a) prepares the sample in a manner suitable for NIR spectrometry.

23. A method for determining the presence, concentration and/or volume in a soil sample of properties selected from the group consisting of: sulphur, carbon, pH, and combinations thereof, comprising:
a) adding at least one aqueous solution to a soil sample; and
b) analysing the result of step (a) via UV/Vis spectrometry;
wherein step (a) is completed within 10 minutes, and further wherein step (a) prepares the sample in a manner suitable for UV/Vis spectrometry.

24. A method for determining the presence, concentration and/or volume in a soil sample of properties selected from the group consisting of: sulphur, carbon, pH, and combinations thereof, comprising:
a) adding at least one aqueous solution to a soil sample; and
b) analysing the result of step (a) via UV/Vis spectrometry;
wherein step (a) is completed under pressure for a time period of 30 to 45 seconds, and further wherein step (a) prepares the sample in a manner suitable for UV/Vis spectrometry.

25. A method for determining the concentration of potassium in a soil sample, comprising:
a) adding an aqueous solution of sodium bicarbonate to a soil sample;
b) adding sodium tetraphenylborate (NaTPB) to the mixture from step (a); and
c) analysing the result of step (b) via NIR spectrometry;
wherein step (a) is completed within 10 minutes, and further wherein steps (a) and (b) prepare the sample in a manner suitable for NIR spectrometry.

26. A method for determining the concentration of potassium in a soil sample, comprising:
a) adding an aqueous solution of sodium bicarbonate to a soil sample;
b) adding sodium tetraphenylborate (NaTPB) to the mixture from step (a); and
c) analysing the result of step (b) via NIR spectrometry;
wherein step (a) is completed under pressure for a time period of 30 to 45 seconds, and further wherein steps (a) and (b) prepare the sample in a manner suitable for NIR spectrometry.

27. A method for determining the concentration of Olsen P phosphorus in a soil sample, comprising:
a) adding an aqueous solution of sodium bicarbonate to a soil sample;
b) adding ammonium molybdate (Olsen P colouring agent) to the mixture from step (a) and degassing the sample; and
c) analysing the result of step (b) via NIR spectrometry;
wherein step (a) is completed within 10 minutes, and further wherein steps (a) and (b) prepare the sample in a manner suitable for NIR spectrometry.

28. A method for determining the concentration of Olsen P phosphorus in a soil sample, comprising:
a) adding an aqueous solution of sodium bicarbonate to a soil sample;
b) adding ammonium molybdate (Olsen P colouring agent) to the mixture from step (a) and degassing the sample; and
c) analysing the result of step (b) via NIR spectrometry;
wherein step (a) is completed under pressure for a time period of 30 to 45 seconds, and further wherein steps (a) and (b) prepare the sample in a manner suitable for NIR spectrometry.
